(19) United States
(12) Patent Application Publication
(10) Pub. No.: US 2008/0151145 A1
(43) Pub. Date: Jun. 26, 2008

(54) LIQUID CRYSTAL DISPLAY ELEMENT AND METHOD OF MANUFACTURING SAME

(75) Inventors: Kazuya Kumazawa, Kanagawa (JP); Tsuyoshi Kamada, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 11/951,047

(22) Filed: Dec. 5, 2007

(30) Foreign Application Priority Data
Dec. 22, 2006 (JP) 2006-345898

(51) Int. Cl. G02F 1/1337; G02F 1/1333

(52) U.S. Cl. 349/84; 349/191

(57) ABSTRACT

Provided is a method of manufacturing a liquid crystal display element which improve aperture ratio of a panel while maintaining good response characteristics against voltage in VA mode using liquid crystal having negative dielectric constant anisotropy. The method of manufacturing a liquid crystal display element includes steps of: sealing, between a couple of substrates facing each other with electrodes formed thereon, a liquid crystal layer containing liquid crystal molecules having a negative dielectric constant anisotropy and a curing material; applying a magnetic field to the liquid crystal layer sealed between the couple of substrates, in a direction to form a predetermined angle with respect to a line normal to the substrates; and curing the curing material after applying the magnetic field.

### CROSS REFERENCES TO RELATED APPLICATIONS

The present invention contains subject matter related to Japanese Patent Application JP 2006-345898 filed in the Japanese Patent Office on Dec. 22, 2006, the entire contents of which being incorporated herein by reference.

### BACKGROUND OF THE INVENTION

1. Field of the Invention

The present invention relates to a vertical alignment type liquid crystal display element provided with a liquid crystal layer having a negative dielectric constant anisotropy, and to a method of manufacturing the liquid crystal display element.

2. Description of the Related Art

Recently, liquid crystal displays have been often used as display monitors of liquid crystal televisions, note book personal computers, car navigations and the like. The liquid crystal displays can be classified into different modes according to the molecular alignment between panel substrates of the liquid crystal displays. For example, a well known is TN (twisted nematic) mode configured by twisted alignment of liquid crystal molecules with no voltage applied thereto. In the TN mode, the liquid crystal molecules have a positive dielectric constant anisotropy, namely the property that the dielectric constant in the molecular long axis direction is larger than that in the molecular short axis direction. In the structure of the TN mode, the liquid crystal molecules are aligned in a direction vertical to the plane of the substrate, while rotating in sequence the alignment direction of liquid crystal molecules in a plane parallel to the substrate.

On the other hand, further attention is paid to VA (vertical alignment) mode where liquid crystal molecules with no voltage applied thereto are aligned vertically to the plane of the substrate. In the VA mode, the liquid crystal molecules have a negative dielectric constant anisotropy, namely the property that the dielectric constant in the molecular long axis direction is smaller than that in the molecular short axis direction. This realizes a wider viewing angle than the TN mode.

A liquid crystal display of the VA mode is configured to transmit light by the phenomenon that in response to the applied voltage, the liquid crystal molecules aligned vertically to the substrate will fall (rise) in a direction parallel to the substrate, due to the negative dielectric constant anisotropy. However, the liquid crystal molecules aligned vertically to the substrate will fall in arbitrary directions, and therefore the alignment of the liquid crystal molecules is disturbed by a voltage application. This contributes to deterioration of response characteristics against voltage.

In view of the foregoing, Japanese Unexamined Patent Application Publications No. 2002-357830 and No. 2002-23199 disclose, as means for regulating the direction of fall in response to a voltage, techniques of aligning liquid crystal molecules in a tilted position in a specific direction from a direction perpendicular to a substrate (namely, imparting a so-called pre-tilt angle) by disposing insulating projections having a tilted surface on the facing surface of the substrate. Alternatively, these publications disclose methods of regulating the alignment by obliquely applying a voltage to liquid crystal molecules under the arrangement that slits (electrode-free portions) are formed in part of pixel electrodes disposed on the facing surface of the substrate and the opposite electrodes of the pixel electrodes. The abovementioned configurations enable predetermination of the direction of fall of liquid crystal molecules when applying a voltage, thereby improving response characteristics against voltage.

### SUMMARY OF THE INVENTION

However, with the configurations of the above publications, for example, in normal black (in the mode of displaying black with no voltage applied), the displays of portions corresponding to the projections become dark visual fields when a voltage is applied. On the other hand, with the configuration of forming the slits in part of the electrodes, in the normal black, the liquid crystal molecules immediately below the slits will fall in the direction perpendicular to a polarization axis, so that black is usually displayed irrespective of turning on and off of a voltage. Due to these problems, the aperture ratio of a panel is lowered, causing a drop in luminance.

It is desirable to provide a method of manufacturing a liquid crystal display element improving the aperture ratio of a panel while maintaining good response characteristics against voltage, in a VA mode using liquid crystal having a negative dielectric constant anisotropy, as well as the liquid crystal display element.

According to an embodiment of the present invention, there is provided a method of manufacturing a liquid crystal display element including steps of: sealing, between a couple of substrates facing each other with electrodes formed thereon, a liquid crystal layer containing liquid crystal molecules having a negative dielectric constant anisotropy and a curing material; applying a magnetic field to the liquid crystal layer sealed between the couple of substrates, in a direction to form a predetermined angle with respect to a line normal to the substrates; and curing the curing material after applying the magnetic field. The predetermined angle means angles larger than 0° and smaller than 90°. In “the step of curing the curing material after applying the magnetic field,” the curing material may be cured after the magnetic field is applied, and with the magnetic field applied.

According to other embodiment of the present invention, there is provided a liquid crystal display element including: a couple of substrates facing each other; a couple of electrodes disposed on facing surfaces of the couple of substrates, respectively; and a liquid crystal layer disposed between the couple of substrates with a couple of electrodes formed thereon, the liquid crystal layer containing pre-tilted liquid crystal molecules having a negative dielectric constant anisotropy. The electrodes are continuous and flat in each pixel.

In the method of manufacturing a liquid crystal display element, the liquid crystal molecules can be aligned in the direction of application of the magnetic field by applying the magnetic field to the liquid crystal layer being sealed between the pair of substrates and containing the curing material, in the direction to form a predetermined angle with respect to the line normal to the substrates. The curing material is then cured to fix the liquid crystal molecules along the direction of application of the magnetic field.

In the liquid crystal display element, the pair of substrates and electrodes are continuous and flat with respect to the liquid crystal layer, and the substrates and the electrodes have neither structural projections nor slits etc. This eliminates the problem of a local dark visual field to be generated in the presence of the projections, slits, or the like.

The method of manufacturing a liquid crystal display element in an embodiment of the present invention includes steps of: sealing, between a couple of substrates facing each other with electrodes formed thereon, a liquid crystal layer containing liquid crystal molecules having a negative dielectric constant anisotropy and a curing material; applying a magnetic field to the liquid crystal layer sealed between the couple of substrates, in a direction to form a predetermined angle with respect to a line normal to the substrates; and curing the curing material after applying the magnetic field. With this method, the so-called pre-tilt angle can be imparted to the liquid crystal molecules, without forming any projections or slits on the substrates and the electrodes. This enables manufacture of the liquid crystal display element improving the aperture ratio of a panel while maintaining good response characteristics against voltage.

The liquid crystal display element in an embodiment of the present invention includes: a pair of oppositely disposed substrates; a pair of electrodes disposed on facing surfaces of the pair of substrates, respectively; and a liquid crystal layer disposed between the pair of electrodes with a vertical alignment film in between, the liquid crystal layer containing liquid crystal molecules having a negative dielectric constant anisotropy and being held in their pre-tilt states. The substrates and the electrodes are continuous and flat with respect to the liquid crystal layer. Accordingly, the aperture ratio of a panel can be improved while maintaining good response characteristics against voltage.

Other and further objects, features and advantages of the invention will appear more fully from the following description.

### BRIEF DESCRIPTION OF THE DRAWINGS

FIG. 1 is a schematic diagram of a liquid crystal panel according to a preferred embodiment of the present invention;

FIG. 2 is a schematic diagram for explaining a method of manufacturing a liquid crystal panel of the preferred embodiment;

FIG. 3 is a schematic diagram for explaining the next succeeding step of FIG. 2;

FIG. 4 is a schematic diagram for explaining the next succeeding step of FIG. 3;

FIG. 5 is a schematic diagram for explaining the next succeeding step of FIG. 4; and

FIG. 6 is a schematic diagram for explaining the next succeeding step of FIG. 5.

### DESCRIPTION OF THE PREFERRED EMBODIMENTS

A preferred embodiment of the present invention will now be described in detail with reference to the accompanying drawings.

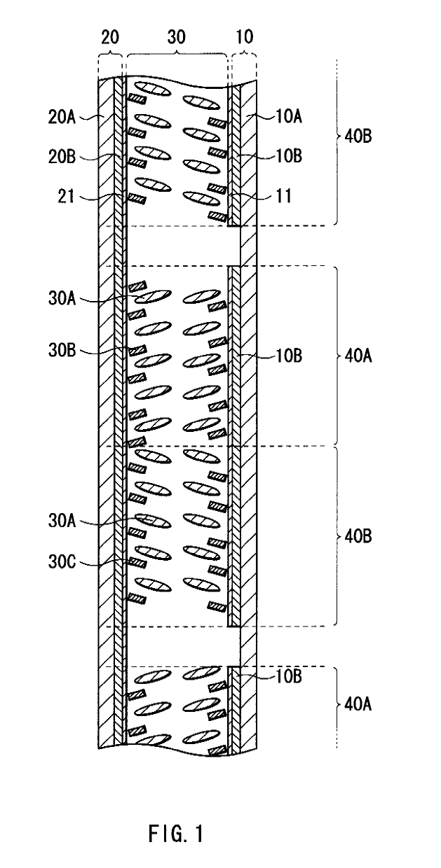

FIG. 1 is a diagram schematically showing the cross-section of a liquid crystal panel according to a preferred embodiment of the present invention. The liquid crystal panel has a liquid crystal layer 30 between a TFT (thin film transistor) substrate 10 and a CF (color filter) substrate 20, with vertical alignment films 11 and 21 in between. The TFT substrate 10 is made up of pixel electrodes 10B for pixels arranged on a glass substrate 10A, respectively. The CF substrate 20 is made up of common electrodes 20B as common electrodes for pixels arranged on a glass substrate 20A, respectively. The liquid crystal layer 30 contains liquid crystal molecules 30A having a negative dielectric constant anisotropy. Each pixel has a first region 40A and a second region 40B, which are of different alignment directions of the liquid crystal molecules 30A.

Any particular projected structures or electrode slits for regulating the alignment directions are not disposed on the liquid crystal panel, and the TFT substrate 10 (the pixel electrodes 10B) and the CF substrate 20 (the common electrodes 20B) are continuous and flat with respect to the liquid crystal layer 30. The liquid crystal molecules 30A are fixed by polymer 30C (held in their pre-tilt states), and the alignment direction thereof is regulated in the liquid crystal layer 30, particularly an interface proximate region between the vertical alignment films 11 and 12. The following is a method of manufacturing the liquid crystal panel.

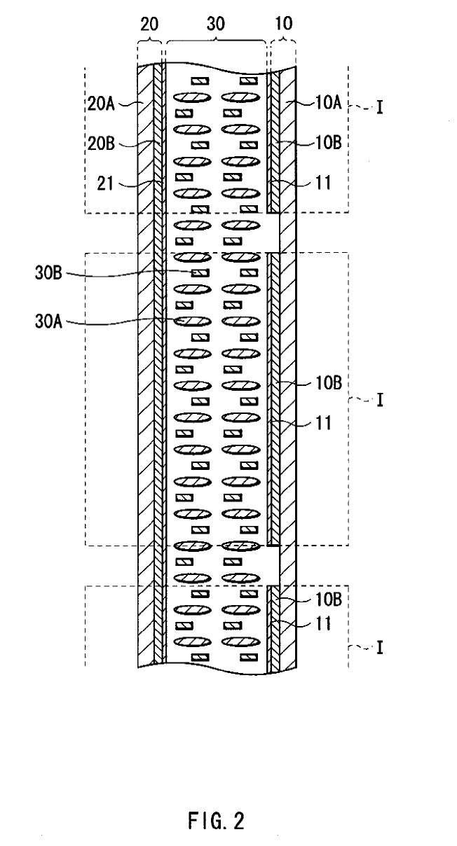

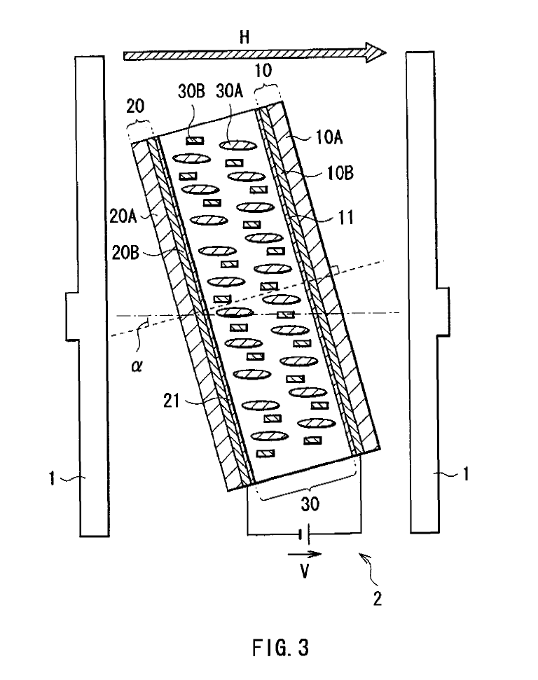

FIGS. 2 to 6 are schematic diagrams showing the steps in the method of manufacturing the liquid crystal panel according to a preferred embodiment of the present invention. This is a method of manufacturing a vertical alignment type liquid crystal display element having a negative dielectric constant anisotropy. This method includes a liquid crystal sealing step of sealing the liquid crystal layer 30 between the TFT substrate 10 and the CF substrate 20; a magnetic field application step of applying a magnetic field; a voltage application step of applying a voltage after applying a magnetic field; and a curing step of curing monomers of the liquid crystal layer 30. Further, domain division of alignment (coexistence of regions having different alignment directions) is performed by repeating the abovementioned steps for each of a plurality of different regions within a pixel of the liquid crystal layer 30. This method is directed to a method of manufacturing a liquid crystal panel where a plurality of pixels are formed between the substrates 10 and 20, as shown in FIG. 2. For sake of simplicity, FIGS. 3 to 6 show only a region I (a pixel) in FIG. 2. In FIGS. 1 to 6, any specific configurations in the TFT substrate 10 and the CF substrate 20 are omitted.

Firstly, as shown in FIG. 2, the liquid crystal layer 30 is sealed between the TFT substrate 10 and the CF substrate 20 (the liquid crystal sealing step).

The TFT substrate 10 is formed by arranging, on a surface of the glass substrate 10A, a plurality of pixel electrodes 10B, for example, in a matrix, a plurality of TFT switching elements each having a gate, a source and a drain for driving these pixel electrodes 10B, and a plurality of signal lines and scanning lines etc connected to these TFT switching elements, respectively. On the other hand, the CF substrate 20 is formed by disposing, on the glass substrate 20A, a color filter (not shown) where filters of, for example, red (R), green (G) and blue (B) are arranged in the shape of a stripe, and disposing the common electrodes 20B over nearly the entire surface of an effective display region. The pixel electrodes 10B and the common electrodes 20B are made up of electrodes having transparency formed of ITO (indium tin oxide), or the like.

Vertical alignment films 11 and 21 for vertically aligning the liquid crystal molecules 30A described later with respect to the substrates are formed on the surfaces of the pixel electrodes 10B of the TFT substrate 10 and on the surfaces of the common electrodes 20B of the CF substrate 20, respectively. Specifically, the vertical alignment films 11 and 21 are formed by applying a vertical alignment material, or alternatively by printing a vertical alignment layer on the substrates, followed by firing. At this time, for alignment control purposes, it is unnecessary to form any projected structures on the surface of the TFT substrate 10 and on the surface of the CF substrate 20, and it is also unnecessary to form any slits (electrode-free regions) in the pixel electrodes 10B and the common electrodes 20B.

The liquid crystal layer 30 is formed of liquid crystal molecules 30A having a negative dielectric constant anisotropy (a negative type nematic liquid crystal). The liquid crystal molecules 30A have the property that the dielectric constant in the molecular long axis direction is larger than that in the molecular short axis direction. Owing to this property, when a voltage is off, the long axes of the liquid crystal molecules 30A are aligned vertically to the substrates, and when the voltage is on, the long axes of the liquid crystal molecules 30A are aligned in a tilted position parallel to the substrates. The liquid crystal layer 30 is composed by adding a material having curing properties, for example, monomers 30B having photo-curing properties. The monomers 30B have the property that under irradiation of light such as ultraviolet light, they are polymerized to be polymer, thereby having curing properties. For example, the monomers 30B are composed of “NK ester A-BP-2E (product name),” manufactured by Shin-Nakamura Chemical Co., Ltd.

Next, spacers for ensuring a cell gap, such as plastic beads, are dispersed in either surface of the TFT substrate 10 or the CF substrate 20, on which the vertical alignment layer 11 or 21 is formed. Subsequently, a seal part is printed with epoxy adhesive etc by, for example, screen printing method. Thereafter, the TFT substrate 10 and the CF substrate 20 are stuck to each other, with the spacers and the seal part in between, so that the vertical alignment layers 11 and 21 formed on the respective substrates 10 and 20 can face to each other. It is followed by admission of the liquid crystal layer 30. The seal part is then cured to seal the liquid crystal layer 30 between the substrates 10 and 20.

Next, as shown in FIG. 3, a magnetic field H is applied to the liquid crystal layer 30 sealed between the substrates (the magnetic field application step). At this time, an angle α° formed between the direction of application of the magnetic field H and the line normal to the substrates satisfies the conditions of: 0°<α<90°. For example, the angle α is 20°. The magnitude of the magnetic field is, for example, 0.05 to 5 T, and the time of application is, for example, 1 to 5 minutes. Preferably, a voltage V (approximately 10V) is further applied after applying the magnetic field H (the voltage application step). The voltage V is applied between the pixel electrodes 10B and the common electrodes 20B, formed on the facing surfaces of the facing substrates, by using voltage applying means 2 as shown in FIG. 3, for example. The voltage V may be applied with the magnetic field H applied, or alternatively applied after temporarily separating from the magnetic field H.

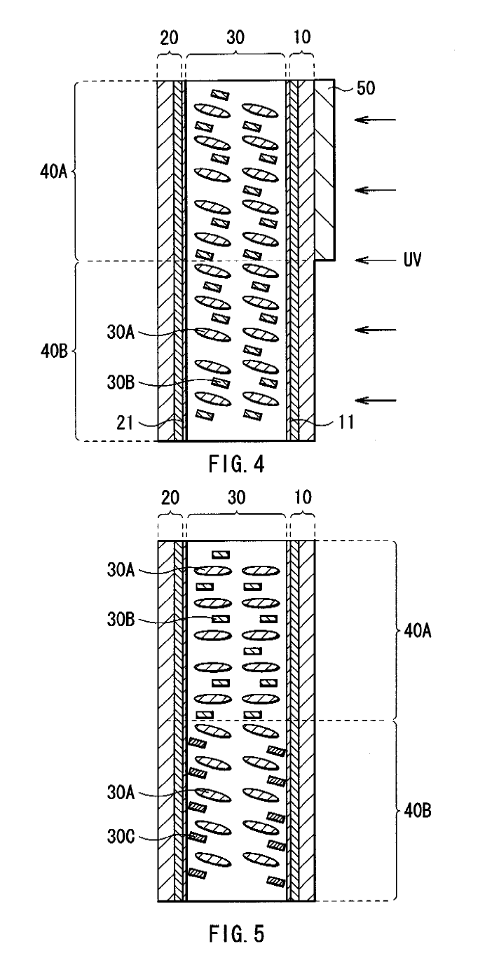

Subsequently, as shown in FIG. 4, the monomers 30B are cured by ultraviolet light UV irradiation to the liquid crystal layer 30 sealed between the substrates 10 and 20 (the curing step). At this time, for example, a mask 50 is put on a first region 40A within a pixel, so that only a second region 40B is exposed. Alternatively, instead of the mask 50, selective exposure may be performed through a quartz substrate having a predetermined aperture pattern (not shown). Alternatively, the abovementioned steps may be repeated a plurality of times through a mask having a different aperture pattern from that of the first exposure. FIG. 5 shows schematically the alignment states of the liquid crystal molecules 30A of the liquid crystal layer 30 obtained through the steps shown in FIGS. 2 to 4. As shown in FIG. 5, in the second region 40B to which the ultraviolet light UV has been irradiated, the monomers 30B are cured to be the polymer 30C, and the liquid crystal molecules 30A are fixed by the polymer 30C in the alignment direction regulated by the abovementioned magnetic field application step and the voltage application step. Whereas in the first region 40A not exposed by the presence of the mask 50, the alignment direction of the liquid crystal molecules 30A cannot be determined and hence returned to their initial states (the vertical states with respect to the substrates 10 and 20). The curing step may be performed after applying the magnetic field H and then applying the voltage V, and with the magnetic field H and the voltage V applied.

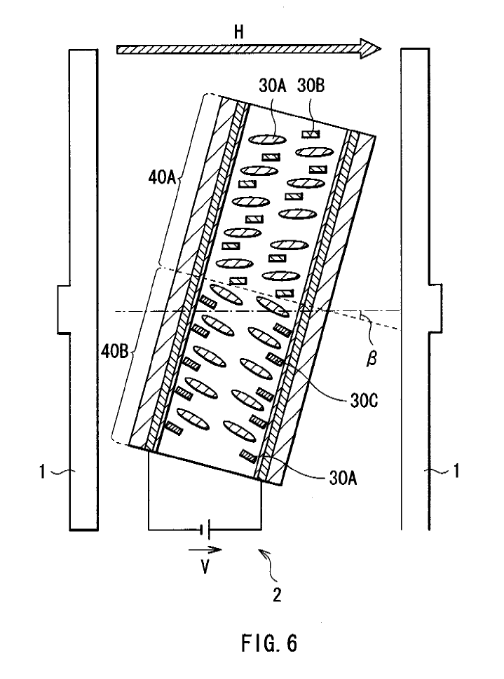

The mask 50 on the TFT substrate 10 is then removed, and the abovementioned steps are repeated for the first region 40A. When the magnetic field H is applied again, as shown in FIG. 6, an angle β° formed between the direction of application of the magnetic field H and the line normal to the substrates satisfies the conditions of: 0°<β<90°, for example, 20°. Here, it is placed under the magnetic field H, so that the long axes of the liquid crystal molecules 30A in the first region 40A are oriented in a different direction from the alignment direction of the liquid crystal molecules 30A in the second region 40B. When ultraviolet light UV is irradiated to the first region 40A (not shown), a mask is preferably used to prevent the second region 40B from being exposed. The reason for this is that if the monomers remaining in the second region 40B are cured by exposure, the polymer might be formed in a different direction from the desired direction, thereby disturbing the regulated alignment of the liquid crystal molecules 30A.

Thus, the liquid crystal panel as shown in FIG. 1 is completed through the foregoing steps. After the abovementioned steps are repeated for the entire region of the liquid crystal layer 30, ultraviolet light UV is preferably irradiated again to the entire surface of the panel under proper conditions (not shown in the figure). By so doing, the monomers remaining in the liquid crystal layer 30 can be reduced to improve the reliability of the panel.

A description will next be made of the effect of the method of manufacturing the liquid crystal panel having the abovementioned configuration, and the effect of the liquid crystal panel.

The method of manufacturing a liquid crystal panel of the present embodiment produces the following effect. That is, in the method of manufacturing the vertical alignment type liquid crystal panel having the negative dielectric constant anisotropy, the liquid crystal molecules 30A can be aligned in the direction of application of the magnetic field H, by applying the magnetic field H to the liquid crystal layer 30 sealed between the substrates 10 and 20, in a direction to form an angle of 0° to 90° with respect to the line normal to the substrates 10 and 20, without requiring formation of any projected structures or electrode slits on the substrates. The reason for this seems to be that the liquid crystal molecules 30A have the dielectric constant anisotropy and also has induced magnetic anisotropy.

The alignment of the liquid crystal molecules 30A can be controlled more properly by applying the voltage V between the substrates 10 and 20, after applying the magnetic field H to the liquid crystal layer 30. Immediately after applying the magnetic field H to the liquid crystal layer 30, the long axes of the liquid crystal molecules 30A in the inside region in the vicinity of the center of the liquid crystal layer 30 are oriented in substantially the same direction as the direction of application of the magnetic field H. On the other hand, the liquid crystal molecules 30A in the interface proximate region between the vertical alignment films 11 and 21 are aligned to have a lower degree of tilt of their long axes (nearly vertical to the substrates 10 and 20) than the liquid crystal molecules 30A in the vicinity of the center. By an additional application of the voltage V to the liquid crystal layer 30 of the above structure, it is possible to increase the tilt of the long axes of the liquid crystal molecules 30A existing in the interface proximate region between the vertical alignment films 11 and 21, with respect to the line normal to the substrates 10 and 20.

Further, the ultraviolet light UV is irradiated to expose the liquid crystal layer 30 in which the monomers 30B having photo-curing properties are contained and the alignment direction of the liquid crystal molecules 30A is regulated. The monomers 30B are polymerized to become the polymer 30C under the exposure. Based on the direction of application of the magnetic field H, the alignment states of the liquid crystal molecules 30A can be determined, and the so-called pre-tilt angle can be imparted to the liquid crystal molecules 30A. Therefore, the local dark viewing field due to the projections or electrode slits etc can be vanished while maintaining the good response characteristics against voltage. This enables manufacture of the liquid crystal panel with the improved aperture ratio of the panel.

The regions having different alignment directions (domain division of alignment) can be easily formed by repeating the abovementioned steps using the mask 50 etc while applying, in different directions, the magnetic field H to a plurality of regions within a pixel of the liquid crystal layer 30. This enables viewing angle characteristics to be improved.

In the liquid crystal panel of the present embodiment, when a voltage is applied between the electrodes in the vertical alignment type liquid crystal panel having the negative dielectric constant anisotropy, the liquid crystal molecules held in their pre-tilt states can be tilted promptly in a certain direction, thereby improving the response speed against voltage. Particularly, within a pixel, neither projections nor electrode slits are disposed in the TFT substrate 10 (the pixel electrodes 11) and the CF substrate 20 (the common electrodes 21) holding the liquid crystal layer 30 in between, that is, these substrates 10 and 20 are continuous and flat with respect to the liquid crystal layer 30. Therefore, the local dark viewing field due to the projections or the electrode slits etc can be vanished to improve the aperture ratio of the panel. Hence, luminance can be improved while maintaining the response characteristics against voltage. It is also possible to improve viewing angle characteristics by the regions having different alignment directions of the liquid crystal molecules within a pixel.

Examples of the present embodiment will be described below.

### EXAMPLES

As an example, the following liquid crystal panel was manufactured in the following manner. Firstly, a vertical alignment film was applied to an array substrate having a TFT, gate lines having a width of 15 μm, data lines having a width of 12 μm, a storage capacitor having a width of 20 μm, and pixel electrodes, and to a color filter substrate having a color filter, common electrodes and 4 μm-spacer projections. Then, a liquid crystal composition containing photo-curing monomers was admitted in drops. Thereafter, the above two substrates were stuck to each other, and seal was cured. Next, a mask was formed on one side of each of the substrates, and arranged so that under the magnetic field, an angle of 20 degrees could be made between the direction of application and the line normal to the panel. After leaving this under the magnetic field for about two minutes, a voltage of 10V was applied to the liquid crystal panel, and the panel was taken out of the magnetic field. The photo-curing monomers contained in the liquid crystal composition were polymerized by ultraviolet light irradiated from the substrate side on which the mask was formed. The mask was then removed from the substrate, and the panel was left again under the magnetic field for about two minutes, so that an angle of 20 degrees can be made between the direction of application and the line normal to the substrates. Similarly, a voltage of 10V was applied, the panel was taken out of the magnetic field, and ultraviolet light was irradiated to polymerize the photo-curing monomers in a different region from those in the previous step. Thus, two regions having different alignment directions were formed within a pixel.

As a comparative example of the liquid crystal panel of the above example, a liquid crystal panel was manufactured in the same manner as in the above example, except that pixel electrodes and common electrodes had slit portions having a width of 10 μm and spacing of 50 μm. The liquid crystal panel of the example and the liquid crystal panel of the comparative example were compared in terms of aperture ratio. The result was that the liquid crystal panel of the example provided an improvement of approximately 25% in aperture ratio over the liquid crystal panel of the comparative example.

While the present invention has been described by the foregoing embodiment and examples, without limiting to these, many changes and modifications may be made. For example, though the foregoing embodiment and examples have described the case of forming two regions having different alignment directions, the number of the regions having different alignment directions may be three or more. Although the voltage applied in the voltage application step is a DC voltage, an AC voltage may be used. The monomers may be cured without applying any voltage after applying a magnetic field to the liquid crystal layer. At this time, after applying the magnetic field, the monomers may be cured with the magnetic field applied. Alternatively, after temporarily taking out of the magnetic field, the monomers may be cured. Although the regions having different alignment directions of liquid crystal molecules (domain division of alignment) are formed by performing the abovementioned steps for each of the different regions within a pixel, the domain division of alignment may be omitted by executing batch processing of the abovementioned steps with respect to the liquid crystal layer within a pixel. Instead of the monomers having photo-curing properties, a material having thermo-curing properties may be used as the curing material.

It should be understood by those skilled in the art that various modifications, combinations, sub-combinations and alterations may occur depending on design requirements and other factors insofar as they are within the scope of the appended claims or the equivalents thereof.

What is claimed is:

1. A method of manufacturing a liquid crystal display element comprising steps of:
sealing, between a couple of substrates facing each other with electrodes formed thereon, a liquid crystal layer containing liquid crystal molecules having a negative dielectric constant anisotropy and a curing material;
applying a magnetic field to the liquid crystal layer sealed between the couple of substrates, in a direction to form a predetermined angle with respect to a line normal to the substrates; and
curing the curing material after applying the magnetic field.

2. The method of manufacturing a liquid crystal display element according to claim 1, further comprising a step of applying between the couple of substrates after applying the magnetic field and before curing the curing material.

3. The method of manufacturing a liquid crystal display element according to claim 1, wherein the step of applying the magnetic field includes:
a first magnetic field application step of applying a magnetic field in a direction to form a predetermined angle with respect to the line normal to the substrates; and
a second magnetic field application step of applying a magnetic field in a direction different from the direction in the first magnetic field application step, and
the step of curing the curing material includes:
a first curing step of curing the curing material existing in a first region in each pixel in the liquid crystal layer by exposing the first region after the first magnetic application step; and
a second curing step of curing the curing material existing in a second region in each pixel in the liquid crystal layer by exposing the second region after the second magnetic application step.

4. A liquid crystal display element comprising:
a couple of substrates facing each other;
a couple of electrodes disposed on facing surfaces of the couple of substrates, respectively; and
a liquid crystal layer disposed between the couple of substrates with a couple of electrodes formed thereon, the liquid crystal layer containing pre-tilted liquid crystal molecules having a negative dielectric constant anisotropy,
wherein the electrodes are continuous and flat in each pixel.
